(19) United States
(12) Patent Application Publication
(10) Pub. No.: US 2017/0032291 A1
(43) Pub. Date: Feb. 2, 2017

(54) Bus Planning Method Using Mobile Communication Data Mining

(71) Applicant: ZTE CORPORATION, Shenzhen, Guangdong (CN)

(72) Inventor: Shuxia LIU, Shenzhen City, Guangdong Province (CN)

(21) Appl. No.: 15/107,438

(22) PCT Filed: Jun. 6, 2014
(86) PCT No.: PCT/CN2014/079385

§ 371 Date: Jun. 22, 2016

(30) Foreign Application Priority Data
Dec. 24, 2013 (CN) 201310723597.8

(51) Int. Cl. G06Q 10/04; G06Q 10/06; H04W 4/02

(52) U.S. Cl. CPC G06Q 10/047; H04W 4/023; G06Q 10/0631; G06Q 50/30

(57) ABSTRACT

A method for using mobile communication data mining to perform bus planning is disclosed, wherein the method comprises: acquiring mobile signaling data of a mobile terminal in a statistic area within a statistic time period from a server of an operator, and acquiring location updating information of the mobile terminal according to the mobile signaling data of the mobile terminal; acquiring a spatiotemporal data set of a user corresponding to each user terminal according to the location updating information of the mobile terminal; acquiring a crowd staying point set and crowd travel characteristics according to the spatiotemporal data set of each user; and performing bus planning according to the crowd staying point set and the crowd travel characteristics, and a device for implementing the above method is further disclosed.

### CROSS-REFERENCE TO RELATED APPLICATION(S)

This application is the U.S. National Phase application of PCT application number PCT/CN2014/079385 having a PCT filing date of Jun. 6, 2014, which claims priority of Chinese patent application 201310723597.8 filed on Dec. 24, 2013, the disclosures of which are hereby incorporated by reference.

### TECHNICAL FIELD

The present invention relates to applying big data mining of mobile communication field to bus line planning of the smart city, in particular to a method for using mobile communication data mining to perform bus planning.

### BACKGROUND OF RELATED ART

Predication of passenger flow volume and passenger flow distribution in bus planning is a basis of a planning solution, and whether a prediction result is scientific and reasonable will finally influence benefit evaluation of the solution. Passenger flow OD investigation (“O” is derived from ORIGIN and refers a departure place of a travel, and “D” is derived from DESTINATION and refers to a destination of the travel), i.e., traffic starting and ending point investigation, is also called as OD traffic volume investigation, and OD traffic volume refers to traffic travel volume between starting and ending points. At present, city passenger flow OD needs to be acquired through citizen travel investigation and a conventional way is to perform a citizen questionnaire survey. Questionnaire survey can only acquire sampling data and cannot reflect travel demands of most residents. Or, an investigator is provided at each door of each bus and the investigators record an arrival time, the number of get-on passengers and the number get-off passengers for each vehicle from morning to night. It is quite complex to perform passenger flow OD observation in a long term, a great amount of manpower, material and financial resources need to be consumed, the accuracy is difficult to be guaranteed, the investigation period is comparatively long and data information is relatively delayed.

At present, the popularizing rate of mobile phones is greatly increased, which reaches more than 80 mobile phones per hundred persons in most provinces and cities. It is expected that, up to 2015, the popularizing rate of mobile phones in China will reach and exceed 100 mobile phones per hundred persons. Currently, there is no related method for using a big data mining technology of mobile signaling data to perform bus planning.

### SUMMARY OF THE INVENTION

The technical problem to be solved by the embodiment of the present invention is to provide a method for using mobile communication data mining to perform bus planning, so as to acquire living trajectory analysis of residents in a given area and acquire crowd flow volume, crowd flow direction, passenger gathering points and staying time through statistics, which are then used for planning, bus stop arrangement and dispatching operation of city bus lines.

In order to solve the above problem, the following technical scheme is adopted.

The embodiment of the present invention provides a method for performing bus planning, and the method uses mobile communication data to perform bus planning, comprising:

acquiring mobile signaling data of a mobile terminal in a pre-set statistic area within a pre-set statistic time period from a server of an operator, and acquiring location updating information of the mobile terminal according to the mobile signaling data of the mobile terminal;

acquiring a spatiotemporal data set of a user corresponding to the mobile terminal according to the location updating information of the mobile terminal;

acquiring crowd data information according to spatiotemporal data sets of a plurality of the users; and

performing bus planning according to the crowd data information.

Alternatively, the crowd data information comprise a crowd staying point set and crowd travel characteristics; and

the step of acquiring crowd data information according to spatiotemporal data sets of a plurality of the users comprises:

extracting a mooring point set of each user according to a spatiotemporal data set of the user;

extracting a mooring repeating point set of each user according to the mooring point set of the user;

summarizing and acquiring the crowd staying point set according to mooring repeating point sets of the plurality of users; and

acquiring travel trajectories of the plurality of users during a going-on-duty time period and travel trajectories of the plurality of users during a going-off-duty time period according to the mooring repeating point sets of the plurality of users, and summarizing and acquiring the crowd travel characteristics.

Alternatively, the step of extracting a mooring point set of each user according to a spatiotemporal data set of the user comprises:

the spatiotemporal data set of the user comprising location points and staying times at the location points; and

extracting a staying time at a location point of the user according to the spatiotemporal data set of the user, and if the staying time at the location point of the user exceeds a pre-set mooring point threshold, marking the location point of the user as a mooring point, establishing the mooring point set of the user, and summarizing and establishing mooring point sets of the plurality of users.

Alternatively, the step of extracting a mooring repeating point set of the user according to the mooring point set of the user comprises:

if a repetition rate of a mooring point in the mooring point set of the user is greater than a pre-set repetition rate threshold, marking the mooring point as a mooring repeating point of the user, establishing the mooring repeating point set of the user, and summarizing and establishing mooring repeating point sets of the plurality of users.

Alternatively, the crowd travel characteristics comprise crowd flow volume, crowd flow direction and crowd characteristic; and

the step of performing bus planning according to the crowd data information comprises:

planning a bus stop location according to the crowd staying point set;

planning bus dispatching according to the crowd flow volume;

merging and optimizing overlapped lines according to the crowd flow direction; and

dispatching and arranging vehicles according to the crowd characteristic.

Alternatively, a device for performing bus planning, wherein the device uses mobile communication data to perform the bus planning and comprises: an information acquisition module, an information transforming module, an information transforming module and a planning module, wherein,

the information collection module is configured to receive mobile signaling data of a mobile terminal in a pre-set statistic area within a pre-set statistic time period from a server of an operator, and acquire location updating information of the mobile terminal according to the mobile signaling data of the mobile terminal;

the information transforming module is configured to receive the location updating information of each mobile terminal and acquire a spatiotemporal data set of a user corresponding to the mobile terminal;

a data mining module is configured to receive spatiotemporal data sets of a plurality of the users and acquire crowd data information; and

the planning module is configured to receive the crowd data information and perform bus planning according to the crowd data information.

Alternatively, the crowd data information comprises a crowd staying point set and crowd travel characteristics; and the data mining module comprises:

a mooring point sub-module configured to receive the spatiotemporal data set of the user and extract a mooring point set of the user;

a mooring repeating point sub-module configured to receive the mooring point set of the user and extract a mooring repeating point set of the user;

a crowd staying point sub-module configured to receive mooring repeating point sets of the plurality of users and summarize and acquire the crowd staying point set; and

a crowd travel characteristic sub-module configured to receive the mooring repeating point sets of the plurality of users, acquire travel trajectories of the plurality of users during a going-on-duty time period and travel trajectories of the plurality of users during a going-off-duty time period, and summarize and acquire the crowd travel characteristics.

Alternatively, the spatiotemporal data set of the user comprises location points and staying times at the location points; and

the mooring point sub-module is configured to receive the spatiotemporal data set of the user and extract a mooring point set of the user in the following way:

extracting a staying time at a location point of the user according to the spatiotemporal data set of the user, and if the staying time at the location point of the user exceeds a pre-set mooring point threshold, marking the location point of the user as a mooring point, establishing the mooring point set of the user and summarizing and establishing mooring point sets of the plurality of users.

Alternatively, the mooring repeating point sub-module is configured to receive the mooring point set of the user and extract a mooring repeating point set of the user in the following way:

if a repetition rate of a mooring point in the mooring point set of the user is greater than a pre-set threshold, marking the mooring point as a mooring repeating point of the user, establishing the mooring repeating point set of the user, and summarizing and establishing mooring repeating point sets of the plurality of users.

Alternatively, the crowd travel characteristics comprise crowd flow volume, crowd flow direction and crowd characteristic; and

the planning module is configured to receive the crowd data information and perform bus planning according to the crowd data information in the following way:

planning a bus stop location according to the crowd staying point set;

planning bus dispatching according to the crowd flow volume;

merging and optimizing overlapped lines according to the crowd flow direction; and

dispatching and arranging vehicles according to the crowd characteristic.

In conclusion, the present invention has the following beneficial effects:

The embodiment of the present invention is based on the method for using mobile communication data to performing bus planning provided by the embodiment of the present invention to acquire mobile communication signaling data of residents in a given area, acquire living trajectory analysis of the residents in the given area through statistics and acquire staying points, crowd flow volume, crowd flow direction and crowd characteristic through statistics, which can be then used as fundamental data for planning and evaluation of a city comprehensive traffic system, thus the input to manpower and material resources in city passenger flow OD investigation is reduced, the consumption is less and the accuracy is high.

### BRIEF DESCRIPTION OF THE DRAWINGS

FIG. 1 is a flowchart of a method for using mobile communication data mining to perform bus planning in the embodiment of the present invention;

FIG. 2 is a typical trajectory of a user going on duty from home;

FIG. 3 is a schematic diagram of crowd staying points;

FIG. 4 is a structural diagram of a device for using mobile communication data mining to perform bus planning in the embodiment of the present invention.

### PREFERRED EMBODIMENTS OF THE INVENTION

Passenger flow OD investigation contents in the embodiment of the present invention mainly include starting and ending point distribution, travel purpose, travel mode, travel time, travel distance, travel times, etc. The above-mentioned information can be conveniently acquired through big data mining of mobile communication signaling data, so as to provide fundamental data for the planning of a city comprehensive traffic system. Key technique points in the present invention are described by only listing the following nonrestrictive examples in combination with the drawings.

The present invention will be alternatively described below in combination with the drawings and the embodiments.

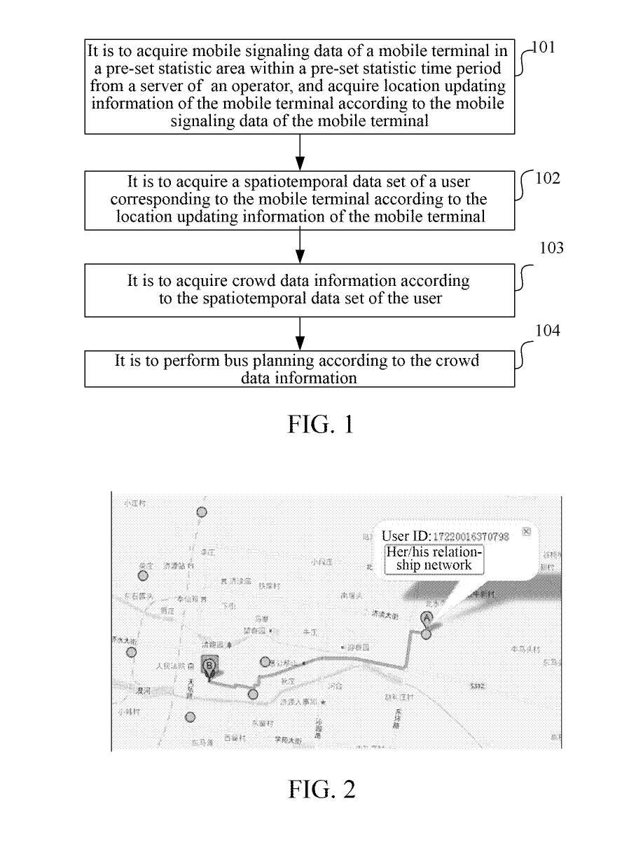

FIG. 1 is a flowchart of a method for performing bus planning provided by the embodiment of the present invention. The method uses mobile communication data to perform the bus planning and comprises the following steps.

In step 101, it is to acquire mobile signaling data of a mobile terminal in a statistic area within a statistic time period from server of an operator, and acquire location updating information of the mobile terminal according to the mobile signaling data of the mobile terminal.

The sources of the acquired mobile signaling data includes, but is not limited to, mobile signaling data, mobile phone GPS location information, etc.

The location updating information includes, but is not limited to, a mobile phone number of the user, a location updating time, a location cell identification, etc.

In step 102, it is to acquire a spatiotemporal data set of a user corresponding to each user terminal according to the location updating information of the mobile terminal.

In step 103, it is to acquire crowd data information according to spatiotemporal data sets of a plurality of users, wherein the crowd data information includes, but is not limited to, a crowd staying point set and crowd travel characteristics.

In this step, the step of acquiring the crowd staying point set and the crowd travel characteristics according to the spatiotemporal data set of each user can comprise the following steps.

In step 1031, it is to extract a mooring point set of the user according to the spatiotemporal data set of the user.

The spatiotemporal data set of the user comprises location points and staying times at the location points.

The staying time at the location point of the user is extracted according to the spatiotemporal data set of the user, and if the staying time at the location point of the user exceeds a pre-set mooring point threshold, the location point of the user is marked as a mooring point, a mooring point set of the user is established, and it is to summarize and establish mooring point sets of the plurality of users.

In step 1032, it is to extract a mooring repeating point set of the user according to the mooring point sets of the users.

If a repetition rate of a mooring point in the mooring point set of the user is greater than a pre-set threshold, the mooring point is marked as a mooring repeating point of the user, a mooring repeating point set of the user is established, and it is to summarize and establish mooring repeating point sets of the plurality of users.

In step 1033, it is to summarize and acquire a crowd staying point set according to mooring repeating point sets of the plurality of users.

In step 1034, it is to acquire travel trajectories of each user during a going-on-duty time period and a going-off-duty time period according to the mooring repeating point sets of the plurality of users, and summarize to acquire crowd travel characteristics.

In step 104, it is to perform bus planning according to the crowd data information, wherein the crowd data information comprises a crowd staying point set and crowd travel characteristics.

A GIS map technology is adopted to associate analysis results of the crowd staying point set and the crowd travel characteristics with information such as traffic lines, community distribution and business area distribution, by which the intuitive planning of bus lines is facilitated.

The crowd travel characteristics comprise crowd flow volume, crowd flow direction and crowd characteristic.

The step of performing bus planning according to the crowd data information comprises:

planning bus stop locations according to the crowd staying point set;

planning bus dispatching according to the crowd flow volume;

merging and optimizing overlapped lines according to the crowd flow direction; and

dispatching and arranging vehicles according to the crowd characteristic.

### Embodiment 1

### City Bus Line Planning

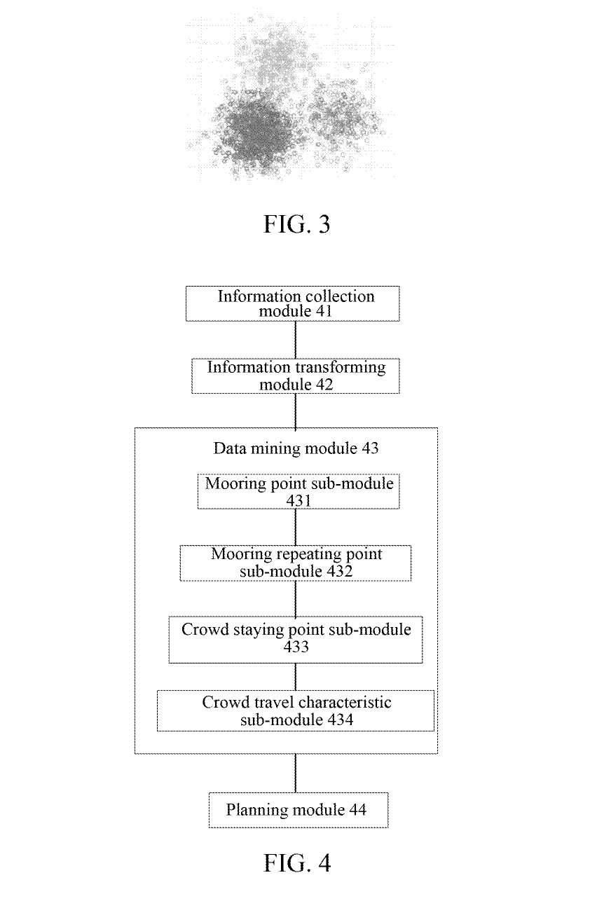

According to daily mooring point analysis of a user (staying at different location areas during different time periods), a daily living trajectory (see FIG. 2) of the user are depicted. Characteristic analysis (repetitive rate and dispersion) is performed on living trajectories of all users in a target area (such as a city, a district or a county) to acquire crowd flow volume dense areas and crowd flow directions at different time periods (see FIG. 3). Bus lines are planned according to crowd flow volume distribution and bus stops are arranged at crowd flow volume dense points. Corresponding implementation steps are as follows:

In step 201, it is to acquire mobile signaling data of a mobile terminal in a statistic area within a statistic time period from an operator server, and acquire location updating information of the mobile terminal according to the mobile signaling data of the mobile terminal.

The acquired mobile signaling data sources include, but are not limited to, mobile signaling data, mobile phone GPS information, etc.

Mobile signaling update data in the first half year (the statistic time period can be set) in a current city (the statistic area can be set) are acquired from an operator to acquire user location updating information including the mobile phone number of the user, location update time and location cell identification within the current time period. The following basic information is acquired from the operator: user registration information including mobile phone number, gender, age, social attribute, etc., alternatively cell information of the base station includes cell identification, cell longitude and latitude, a cell radius, a cell administration address, etc.

In step 202, it is to acquire a spatiotemporal data set of a user corresponding to the mobile terminal according to the location updating information of the mobile terminal.

In combination with the data source in the above-mentioned step, everyday 24-hour real-time moving trajectory of the user is analyzed (see FIG. 2), dynamic changes of user locations with time are recorded, and a spatiotemporal data set A of the user is established and comprises the following information: a location point p (it is to grid a map according to radio cell coverage situations in the city, one cell corresponds to one grid and a grid location of the cell is coded as P), the time t1 of entering the location point and the time t2 of leaving the location point.

In step 203, it is to acquire a crowd staying point set and crowd travel characteristics according to spatiotemporal data sets of a plurality of users.

In this step, the step of acquiring the crowd staying point set and the crowd travel characteristics according to the spatiotemporal data set of each user can comprise the following steps.

In step 2031, it is to extract a mooring point set of the user according to the spatiotemporal data set of the user.

The spatiotemporal data set of the user comprises location points and staying times at the location points.

A staying time at a location point of the user is extracted according to the spatiotemporal data set of the user, and if the staying time at the location point of the user exceeds a pre-set mooring point threshold, the location point of the user is marked as a mooring point, a mooring point set of the user is established and it is to summarize and establish mooring point sets of the plurality of users.

The step of extracting the mooring point set of the user comprises: judging whether a state of each point in the spatiotemporal data set A of the user is in a moving state or a staying state, determining the state when the staying time (t2−t1) at the point exceeds 1 hour (the mooring point threshold can be adjusted) to be a staying state, adding this location point into a mooring point set B of the user, and determining the state when the staying time at the point does not exceed 1 hour (the mooring point threshold can be adjusted) to be a moving state.

In step 2032, it is to extract a mooring repeating point set of each user according to the mooring point set of each user.

If a repetition rate of a mooring point in the mooring point set of the user is greater than a pre-set threshold, the mooring point is marked as a mooring repeating point of the user, a mooring repeating point set of the user is established and it is to summarize and establish mooring repeating point sets of the plurality of users.

The step of extracting the mooring repeating point set comprises: taking a mooring point with a repetition rate being greater than 0.7 (the threshold can be adjustable) as a conventional mooring point of the user, and establishing a mooring repeating point set C. Calculating the repetition rate of the mooring point comprises, but is not limited to, the following way: mooring points on a first day belong to a set B1, mooring points on a second day belong to a set B2, a repetition rate of the two days is the number of points in an intersection set of B1 and B2/the number of points in a union set of B1 and B2, and it can be extended to one week or one month accordingly. Repetition rates at daytime, nighttime, going-on-duty time, weekends and the like can also be respectively calculated.

In step 2033, it is to summarize according to mooring repeating point sets of a plurality of users to acquire a crowd staying point set.

The step of extracting the crowd staying point set comprises: summarizing mooring repeating points of all users in the area to acquire a crowd mooring point set D, such that a change situation of the of number of persons within 24 hours in a day in each map grid can be acquired and data accuracy is 1 hour (the data accuracy can be adjusted); and marking grids with the number of person exceeding 6 (the judgment threshold can be adjusted according to the demands) as staying points, and establishing a crowd staying point set E, wherein staying point information comprises a location point, the number of persons, a staying time period, etc.

In step 2034, it is to acquire travel trajectories of the plurality of user during a going-on-duty time period and travel trajectories of the plurality of user during a going-off-duty time period according to the mooring repeating point sets of the plurality of users, and summarize and acquire crowd travel characteristics.

The step of judging mooring point characteristics comprises: marking mooring repeating points with the staying time being from 20:00 pm to 6:00 am of the next day in the mooring repeating point set C as user home addresses, and marking mooring repeating points with the staying time being from 9:30 am to 11:30 am or from 14:00 pm to 16:30 pm of workdays in the mooring repeating point set C as user office locations, wherein the judgment conditions can be adjusted according to the local time and the home addresses and working addresses can be multiple.

The step of analyzing user travel characteristics of the user comprises: determining travel trajectories from homes to offices, i.e., starting points are the home addresses, and ending points are the office locations, as travel trajectories during a going-on-duty time period; and determining travel trajectories from offices to homes, i.e., starting points are the office locations and ending points are the home addresses, as travel trajectories during a going-off-duty time period.

The step of extracting the crowd travel characteristics comprises: summarizing travel characteristics of all users in the area to acquire travel characteristics of crowd in the area, i.e., original passenger flow OD data (departure-arrival information of crowd at a certain time period).

In step 204, it is to perform bus planning according to the crowd data information, wherein the crowd data information comprises a crowd staying point set and crowd travel characteristics.

A GIS map technology is adopted to associate analysis results of the crowd staying point set and the crowd travel characteristics with information such as traffic lines, community distribution and business area distribution, and by which the intuitive planning of bus lines is facilitated.

The crowd travel characteristics comprise crowd flow volume, crowd flow direction and crowd characteristic.

The step of performing bus planning according to the crowd data information comprises:

planning bus lines according to the crowd travel characteristics (passenger flow OD data), wherein the crowd flow volume can be expanded according to mobile phone possessed amount per capita of the city; and

planning bus stop locations according to the crowd staying point set.

### Embodiment 2

### Bus Line Optimization

A bus company should add lines and the number of runs in areas with dense populations. By adding the lines, passengers can catch buses that run to different locations at the same location, such that not only can convenience be provided to the passengers, but also more passengers can be brought to the buses. Corresponding implementation steps are as follows:

In step 301, it is to acquire mobile signaling data of a mobile terminal in a pre-set statistic area within a pre-set statistic time period from an operator server, and acquire location updating information of the mobile terminal according to the mobile signaling data of the mobile terminal.

The acquired mobile signaling data sources comprise, but are not limited to, mobile signaling data, mobile phone GPS information, etc.

Mobile signaling update data in the first half year (the statistic period can be set) in a current city (the statistic area can be set) are acquired from an operator to acquire user location updating information including the user mobile phone number, location update time and location cell identification within the current time period. The following basic information is acquired from the operator: user registration information including mobile phone number of the user, gender, age, social attribute, etc., and alternatively cell information of the base station includes cell identification, cell longitude and latitude, cell radius, cell administration address, etc.

In step 302, it is to acquire a spatiotemporal data set of a user corresponding to each user terminal according to the location updating information of the mobile terminal.

In combination with the data source in the above-mentioned step, everyday 24-hour real-time moving trajectory of the user is analyzed (see FIG. 2), dynamic changes of user locations with time are recorded, and a spatiotemporal data set A of the user is established and comprises the following information: a location point p (it is to grid a map according to city radio cell coverage situations, one cell corresponds to one grid and a grid location of cell is coded as P), the time t1 of entering the location point and the time t2 of leaving the location point.

In step 303, it is to acquire crowd data information according to spatiotemporal data sets of the users, wherein the crowd data information comprises a crowd staying point set and crowd travel characteristics.

In this step, the step of acquiring the crowd data information according to the spatiotemporal data set of each user comprises the following steps.

In step 3031, it is to extract a mooring point set of each user according to the spatiotemporal data set of each user.

The spatiotemporal data set of the user comprises location points and staying times at the location points.

A staying time at a location point of the user is extracted according to the spatiotemporal data set of the user, and if the staying time at the location point of the user exceeds a pre-set mooring point threshold, the location point of the user is marked as a mooring point, a mooring point set of the user is established and it is to summarize and establish mooring point sets of the plurality of users.

The step of extracting the mooring point set of the user comprises: judging whether a state of each point in the spatiotemporal data set A of the user is in a moving state or a staying state, determining the state when the staying time (t2−t1) at the point exceeds 1 hour (the mooring point threshold can be adjusted) to be a staying state, adding this location point into a mooring point set B of the user, and determining the state when the staying time at the point does not exceed 1 hour (the mooring point threshold can be adjusted) to be a moving state.

In step 3032, it is to extract a mooring repeating point set of the user according to the mooring point sets of the plurality of users.

If a repetition rate of a mooring point in the mooring point set of the user is greater than a pre-set threshold, the mooring points are marked as repetitive mooring points of the user, a mooring repeating point set of the user is established and it is to summarize and establish mooring repeating point sets of the plurality of users.

The step of extracting the mooring repeating point set comprises: taking mooring points with a repetition rate greater than 0.7 (the threshold can be adjustable) as conventional mooring points of the user, and establishing a mooring repeating point set C. Calculating the repetition rate of the mooring points includes, but is not limited to, the following way: mooring points on a first day belong to a set B1, mooring points on a second day belong to a set B2, a repetition rate of the two days is the number of points in an intersection set of B1 and B2/the number of points in a union set of B1 and B2 and it can be extended to one week or one month accordingly. Repetition rates at daytime, nighttime, going-on-duty time, weekends and the like can also be respectively calculated.

In step 3033, it is to summarize according to the mooring repeating point set of each user to acquire a crowd staying point set.

The step of extracting the crowd staying point set comprises: summarizing mooring repeating points of all users in the area to acquire a crowd mooring point set D, such that a change situation of the number of persons within 24 hours of a day in each map grid can be acquired and data accuracy is 1 hour (the data accuracy can be adjusted); and marking grids with the number of persons exceeding 6 (the judgment threshold can be adjusted according to the need) as staying points, and establishing a crowd staying point set E, wherein staying point information comprises a location point, the number of persons, a staying time period, etc.

In step 3034, it is to acquire travel trajectories of a plurality of user during a going-on-duty time period and travel trajectories of the plurality of user during a going-off-duty time period according to the mooring repeating point sets of the plurality of users, and summarize and acquire crowd travel characteristics.

The step of judging mooring point characteristics comprises: marking mooring repeating points with the staying time being from 20:00 pm to 6:00 am of the next day in the mooring repeating point set C as user home addresses, and marking mooring repeating points with the staying time being from 9:30 am to 11:30 am or from 14:00 pm to 16:30 pm of workdays in the mooring repeating point set C as user office locations, wherein the judgment conditions can be adjusted according to the local time and the home addresses and working addresses can be multiple.

The step of analyzing user travel characteristics of the user comprises: determining travel trajectories from homes to offices, i.e., starting points are the home addresses and ending points are the office locations, as travel trajectories during a going-on-duty time period; and determining travel trajectories from offices to homes, i.e., starting points are the office locations and ending points are the home addresses, as travel trajectories during a going-off-duty time period.

The step of extracting the crowd travel characteristics comprises: summarizing travel characteristics of all users in the area to acquire travel characteristics of crowd in the area, i.e., original passenger flow OD data (departure-arrival information of crowd at a certain time period).

In step 304, it is to perform bus planning according to the crowd data information, wherein the crowd data information comprises a crowd staying point set and crowd travel characteristics.

A GIS map technology is adopted to connect analysis results of the crowd staying point set and the crowd travel characteristics with information such as traffic lines, community distribution and business area distribution, and by which the intuitive planning of bus lines is facilitated.

The crowd travel characteristics comprise crowd flow volume, crowd flow direction and crowd characteristic.

The step of performing bus planning according to the crowd data information comprises:

merging and optimizing overlapped lines according to the crowd flow direction of the crowd travel characteristics.

### Embodiment 3

### Bus Dispatching Optimization

Staying times, i.e., waiting times of passengers at stops are acquired through statistics. For stops with great crowd flow volume and long staying time, the number of bus runs need to be increased. By increasing the number of runs, the waiting time of the passengers can be greatly shortened, and not only can the time of the passengers be saved, but also the competitiveness of buses can be improved. Bus types can also be adjusted according to user group characteristics. Corresponding implementation steps are as follows.

In step 401, it is to acquire mobile signaling data of a mobile terminal in a pre-set statistic area within a pre-set statistic period from a server of an operator, and acquire location updating information of the mobile terminal according to the mobile signaling data of the mobile terminal.

The acquired mobile signaling data sources include, but are not limited to, mobile signaling data, mobile phone GPS information, etc.

Mobile signaling update data in the first half year (the statistic time period can be set) in a current city (the statistic area can be set) are acquired from an operator, and user location updating information including the user mobile phone number, location updating time and location cell identification within the current time period are acquired. The following basic information is acquired from the operator: user registration information including mobile phone number, gender, age, social attribute, etc., and alternatively cell information of base station includes cell identification, cell longitude and latitude, cell radius, a cell administration address, etc.

In step 402, it is to acquire a spatiotemporal data set of a user corresponding to each user terminal according to the location updating information of the mobile terminal.

In combination with the data source in the above-mentioned step, everyday 24-hour real-time moving trajectory of the user is analyzed (see FIG. 2), dynamic changes of user locations with time are recorded, and a spatiotemporal data set A of the user is established and comprises the following information: a location point p (it is to grid a map according to city radio cell coverage situations, one cell corresponds to one grid and a grid location of the cell is coded as P), the time t1 of entering the location point and the time t2 of leaving the location point.

In step 403, it is to acquire crowd data information according to spatiotemporal data sets of the users, wherein the crowd data information comprises a crowd staying point set and crowd travel characteristics.

In this step, the step of acquiring the crowd data information according to the spatiotemporal data set of each user comprises the following steps.

In step 4031, it is to extract a mooring point set of each user according to the spatiotemporal data set of each user.

The spatiotemporal data set of the user comprises location points and staying times at the location points.

A staying time at a location point of the user is extracted according to the spatiotemporal data set of the user, and if the staying time at the location point of the user exceeds a pre-set mooring point threshold, the location point of the user is marked as a mooring point, a mooring point set of the user is established and it is to summarize and establish mooring point sets of the plurality of users.

The step of extracting the mooring point set of the user comprises: judging whether a state of each point in the spatiotemporal data set A of the user is in a moving state or a staying state, determining the state when the staying time (t2−t1) at the point exceeds 1 hour (the mooring point threshold can be adjusted) to be a staying state, adding this location point into a mooring point set B of the user, and determining the state when the staying time at the point does not exceed 1 hour (the mooring point threshold can be adjusted) to be a moving state.

In step 4032, it is to extract mooring repeating point sets of the plurality of users according to the mooring point sets of the plurality of users.

If a repetition rate of a mooring point in the mooring point set of the user is greater than a pre-set threshold, the mooring point is marked as mooring repeating point of the user, a mooring repeating point set of the user is established and it is to summarize and establish mooring repeating point sets of the plurality of users.

The step of extracting the mooring repeating point set comprises: taking mooring points with a repetition rate greater than 0.7 (the threshold can be adjustable) as conventional mooring points of the user, and establishing a mooring repeating point set C. Calculating the repetition rate includes, but is not limited to, the following way: mooring points on a first day belong to a set B1, mooring points on a second day belong to a set B2, a repetition rate of the two days is the number of points in an intersection set of B1 and B2/the number of points in a union set of B1 and B2, and it can be extended to one week or one month accordingly. Repetition rates at daytime, nighttime, going-on-duty time period, weekends and the like can also be respectively calculated.

In step 4033, it is to summarize and acquire a crowd staying point set according to the mooring repeating point sets of the plurality of users.

The step of extracting the crowd staying point set comprises: summarizing repetitive mooring points of all users in the area to acquire a crowd mooring point set D, such that a change situation of the number of persons within 24 hours of a day in each map grid can be acquired and data accuracy is 1 hour (the data accuracy can be adjusted); and marking grids with the number of persons exceeding 6 (the judgment threshold can be adjusted according to the need) as staying points, and establishing a crowd staying point set E, wherein staying point information comprises a location point, the number of persons, a staying period, etc.

In step 4034, it is to acquire travel trajectories of a plurality of user during a going-on-duty time period and a going-off-duty time period according to the mooring repeating point sets of the plurality of users, and summarize and acquire crowd travel characteristics.

The step of judging mooring point characteristics: marking mooring repeating points with the staying time being from 20:00 pm to 6:00 am of the next day in the mooring repeating point set C as user home addresses, and marking mooring repeating points with the staying time being from 9:30 am to 11:30 am or from 14:00 pm to 16:30 pm of workdays in the mooring repeating point set C as user office locations, wherein the judgment conditions can be adjusted according to the local time and the home addresses and working addresses can be multiple.

The step of analyzing user travel characteristics of the user comprises: determining travel trajectories from homes to offices, i.e., starting points are the home addresses and ending points are the office locations, as travel trajectories during a going-on-duty time period; and determining travel trajectories from offices to homes, i.e., starting points are the office locations and ending points are the home addresses, as travel trajectories during a going-off-duty time period.

The analysis of user travel characteristics further comprises user characteristic analysis. Contents of user characteristic analysis comprise age (old, middle, young and juvenile), gender (male and female), social attribute (worker, students and shopper), etc.

The step of extracting the crowd travel characteristics comprises: summarizing travel characteristics of all users in the area and acquiring travel characteristics of crowd in the area, i.e., original passenger flow OD data (departure-arrival information of crowd at a certain time period). Contents of the crowd travel characteristics comprise crowd flow volume (the number of persons), crowd flow direction (starting location and arrival location), travel time, crowd characteristic (the number of persons statistically acquired in groups according to age, gender, social attribute and the like), etc.

In step 404, it is to perform bus planning according to the crowd data information, wherein the crowd data information comprises a crowd staying point set and crowd travel characteristics.

A GIS map technology is adopted to associate analysis results of the crowd staying point set and the crowd travel characteristics with information such as traffic lines, community distribution and business area distribution, and by which the intuitive planning of bus lines is facilitated.

The crowd travel characteristics comprise crowd flow volume, crowd flow direction and crowd characteristic.

The step of performing bus planning according to the crowd data information comprises:

planning bus dispatching according to the crowd flow volume of the crowd travel characteristics (crowd are expanded according to mobile phone possessed amount per capita of the city), including departure interval and departure bus types, wherein for a time period with a great crowd flow volume, the departure interval is shortened, the number of bus runs are increased and the bus types with great capacity are arranged; and

dispatching and arranging vehicles according to the crowd characteristic of the crowd travel characteristics, wherein the bus types with many seats and low footboards are arranged for old passengers.

As shown in FIG. 4, the embodiment of the present invention further provides a device for using mobile communication data mining to perform bus planning, which comprises an information collection module 41, an information transforming module 42, a data mining module 43 and a planning module 44, wherein,

the information collection module 41 is configured to receive mobile signaling data of mobile terminal in a pre-set statistic area within a statistic time period from a server of an operator, and acquire location updating information of the mobile terminal according to the mobile signaling data of the mobile terminal;

the information transforming module 42 is configured to receive the location updating information of the mobile terminal and acquire a spatiotemporal data set of a user corresponding to the mobile terminal;

the data mining module 43 is configured to receive spatiotemporal data sets of a plurality of users and acquire crowd data information; and

the planning module 44 is configured to receive the crowd data information and perform bus planning according to the crowd data information.

Therein, the crowd data information comprises a crowd staying point set and crowd travel characteristics; and

the data mining module 43 comprises:

a mooring point sub-module 431 configured to receive the spatiotemporal data set of the user and extract a mooring point set of the user;

a mooring repeating point sub-module 432 configured to receive the mooring point set of the user and extract a mooring repeating point set of the user;

a crowd staying point sub-module 433 configured to receive mooring repeating point sets of a plurality of users and summarize and acquire the crowd staying point set; and

a crowd travel characteristic sub-module 434 configured to receive the mooring repeating point sets of the plurality of users, acquire travel trajectories of the plurality of users during a going-on-duty time period and a going-off-duty time period, and summarize and acquire the crowd travel characteristics.

For other functions of the device, please refer to the description for the contents of the method.

From the above-mentioned embodiments, it can be seen that, when the technical scheme of the present invention performs bus planning by using mobile communication data mining, mobile communication signaling data of residents in a given area are acquired, living trajectory analysis of the residents in the given area are acquired through statistics and staying points, crowd flow volume, crowd flow direction and crowd characteristic are acquired through statistics, which can be then used as fundamental data for planning and evaluation of a city comprehensive traffic system, such that the input of manpower and material resources in city passenger flow OD investigation is reduced, the consumption is less and the accuracy is high.

One skilled in the art can understand that all or partial steps in the above-mentioned methods can be completed by relevant hardware instructed by a program, and the program can be stored in a computer readable storage medium such as a read only memory, a magnetic disk or a compact disk. Alternatively, all or partial steps of the above-mentioned embodiments can also be implemented by using one or more integrated circuits. Correspondingly, each module/unit in the above-mentioned embodiments can be implemented by means of hardware, and can also be implemented by means of a software function module. The present invention is not limited to combinations of hardware and software in any specific form.

The embodiments are just preferred embodiments of the present invention and are not used for limiting the present invention. For one skilled in the art, the present invention may have various modifications and variations. Any modification, equivalent replacement, improvement and the like made within the essence and principle of the present invention shall also be included in the protection range of the present invention.

### INDUSTRIAL APPLICABILITY

The method for perform bus planning provided by the embodiment of the present invention is based on using mobile communication data mining, so as to acquire mobile communication signaling data of residents in a given area, acquire living trajectory analysis of the residents in the given area through statistics and acquire staying points, crowd flow volume, crowd flow direction and crowd characteristic through statistics, which can be then used as fundamental data for planning and evaluation of a city comprehensive traffic system, such that the input of manpower and material resources in city passenger flow OD investigation is reduced, the consumption is less and the accuracy is high. Therefore, the present invention has a very strong industrial applicability.

What is claimed is:

1. A method for performing bus planning, wherein the method uses mobile communication data to perform bus planning, comprising:
acquiring mobile signaling data of a mobile terminal in a pre-set statistic area within a pre-set statistic time period from a server of an operator, and acquiring location updating information of the mobile terminal according to the mobile signaling data of the mobile terminal;
acquiring a spatiotemporal data set of a user corresponding to the mobile terminal according to the location updating information of the mobile terminal;
acquiring crowd data information according to spatiotemporal data sets of a plurality of the users; and
performing bus planning according to the crowd data information.

2. The method for performing bus planning according to claim 1, wherein,
the crowd data information comprise a crowd staying point set and crowd travel characteristics; and
the step of acquiring crowd data information according to spatiotemporal data sets of a plurality of the users comprises:
extracting a mooring point set of the user according to the spatiotemporal data set of the user;
extracting a mooring repeating point set of the user according to the mooring point set of the user;
summarizing and acquiring the crowd staying point set according to mooring repeating point sets of the plurality of users; and
acquiring travel trajectories of the plurality of users during a going-on-duty time period and travel trajectories of the plurality of users during a going-off-duty time period according to the mooring repeating point sets of the plurality of users, and summarizing and acquiring the crowd travel characteristics.

3. The method for performing bus planning according to claim 2, wherein the step of extracting a mooring point set of the user according to the spatiotemporal data set of the user comprises:
the spatiotemporal data set of the user comprising location points and staying times at the location points;
extracting a staying time at a location point of the user according to the spatiotemporal data set of the user, and if the staying time at the location point of the user exceeds a pre-set mooring point threshold, marking the location point of the user as a mooring point, establishing the mooring point set of the user, and summarizing and establishing mooring point sets of the plurality of users.

4. The method for performing bus planning according to claim 2, wherein the step of extracting a mooring repeating point set of the user according to the mooring point set of the user comprises:
if a repetition rate of a mooring point in the mooring point set of the user is greater than a pre-set repetition rate threshold, marking the mooring point as a mooring repeating point of the user, establishing the mooring repeating point set of the user, and summarizing and establishing mooring repeating point sets of the plurality of users.

5. The method for performing bus planning according to claim 2, wherein:
the crowd travel characteristics comprise crowd flow volume, crowd flow direction and crowd characteristic; and
the step of performing bus planning according to the crowd data information comprises:
planning a bus stop location according to the crowd staying point set;
planning bus dispatching according to the crowd flow volume;
merging and optimizing overlapped lines according to the crowd flow direction; and
dispatching and arranging vehicles according to the crowd characteristic.

6. A device for performing bus planning, wherein the device uses mobile communication data to perform bus planning, comprising: an information collection module, an information transforming module, a data mining module and a planning module, wherein,
the information collection module is configured to receive mobile signaling data of a mobile terminal in a pre-set statistic area within a pre-set statistic time period from a server of an operator, and acquire location updating information of the mobile terminal according to the mobile signaling data of the mobile terminal;
the information transforming module is configured to receive the location updating information of the mobile terminal and acquire a spatiotemporal data set of a user corresponding to the mobile terminal;
the data mining module is configured to receive spatiotemporal data sets of a plurality of the users and acquire crowd data information; and
the planning module is configured to receive the crowd data information and perform bus planning according to the crowd data information.

7. The device for performing bus planning according to claim 6, wherein,
the crowd data information comprises a crowd staying point set and crowd travel characteristics; and
the data mining module comprises:
a mooring point sub-module configured to receive the spatiotemporal data set of the user and extract a mooring point set of the user;
a mooring repeating point sub-module configured to receive the mooring point set of the user and extract a mooring repeating point set of the user;
a crowd staying point sub-module configured to receive mooring repeating point sets of the plurality of users and summarize and acquire the crowd staying point set; and
a crowd travel characteristic sub-module configured to receive the mooring repeating point sets of the plurality of users, acquire travel trajectories of the plurality of users during a going-on-duty time period and travel trajectories of the plurality of users during a going-off-duty time period, and summarize and acquire the crowd travel characteristics.

8. The device for performing bus planning according to claim 7, wherein the spatiotemporal data set of the user comprises location points and staying times at the location points; and
the mooring point sub-module is configured to receive the spatiotemporal data set of the user and extract a mooring point set of the user in the following way:
extracting a staying time at a location point of the user according to the spatiotemporal data set of the user, and if the staying time at the location point of the user exceeds a pre-set mooring point threshold, marking the location point of the user as a mooring point, establishing mooring point set of the user and summarizing and establishing mooring point sets of the plurality of users.

9. The device for performing bus planning according to claim 7, wherein the mooring repeating point sub-module is configured to receive the mooring point set of the user and extract a mooring repeating point set of the user in the following way:
if a repetition rate of a mooring point in the mooring point set of the user is greater than a pre-set threshold, marking the mooring point as a mooring repeating point of the user, establishing the mooring repeating point set of the user, and summarizing and establishing mooring repeating point sets of the plurality of users.

10. The device for performing bus planning according to claim 7, wherein the crowd travel characteristics comprise crowd flow volume, crowd flow direction and crowd characteristic; and
the planning module is configured to receive the crowd data information and perform bus planning according to the crowd data information in the following way:
planning a bus stop location according to the crowd staying point set;
planning bus dispatching according to the crowd flow volume;
merging and optimizing overlapped lines according to the crowd flow direction; and
dispatching and arranging vehicles according to the crowd characteristic.
